(19) United States
(12) Patent Application Publication
(10) Pub. No.: US 2005/0121078 A1
(43) Pub. Date: Jun. 9, 2005

(54) Automatic dosing pressure chamber distribution of effluent

(76) Inventors: Roy Oneil Hebert, Eureka Springs, AR (US); Kenneth Milton Collins, Berryville, AR (US)

Correspondence Address: Roy Hebert, 15 Douglas St., Eureka Springs, AR, 72632, US

(21) Appl. No.: 10/946,266

(22) Filed: Sep. 20, 2004

Related U.S. Application Data
(60) Provisional application No. 60/528,575, filed on Dec. 9, 2003.

(51) Int. Cl. F16K 21/18

(52) U.S. Cl. 137/397

(57) ABSTRACT

A septic tank effluent distribution device, which is comprised of an influent collection chamber, a novel automatic dosing mechanism in conjunction with a pressure distribution chamber. The equal distribution of effluent resulting from this invention greatly improves the efficiency of gravity flow distribution systems. This device is intended to install as the distribution box for any slow-flow soil absorption system, transforming the distribution efficiency of the system to that of a powerful dose, using a simple and reliable technology.

### CROSS-REFERENCE TO RELATED APPLICATIONS

This application claims the benefit of PPA Appl. No. 60/528,575 filed Dec. 9, 2003 by the present inventors.

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to liquid distribution, specifically to equal distribution of wastewater for residential septic systems.

### BACKGROUND OF THE INVENTION

During the many decades of sewage disposal into soil absorption systems, one of the major problems has been malfunction caused by unequal effluent loading of the various distribution lines, resulting in the surfacing of sewage in the most heavily loaded area. Many ideas and designs have attempted to solve this age-old problem. Some progress has been made through the years to minimize the failure effects of unequal effluent loading throughout the absorption area. However, the problem has not been fully resolved by the application of a simple, economical device that is easy to install and unfailingly distributes effluent equally over the entire absorption field.

The designers of wastewater treatment systems must consider many critical factors in the design and layout of an absorption system. The calculated size of the drain field area takes into consideration that the entire area will be used for the intended subsurface absorption of the wastewater discharge, assuming the equal distribution of effluent within all the drain lines. In actual practice, equal distribution is rarely accomplished.

The components and materials used in installation will limit the function of even the best-designed system. Successful operation of the system depends on all components functioning as intended. Typically, the weak link has been the unsatisfactory performance of liquid distribution units, called D-boxes. Most commonly they operate by controlling the effluent distribution by leveling the box and adjusting the outlet orifices to obtain the best distribution possible at the time of installation. In a short period of time, the box becomes unleveled due to soil settling, causing the slow-flowing effluent to be distributed unevenly as it flows through the D-box.

The primary reason for this unequal distribution is the nature of slow-flowing sewage to follow the path of least resistance through multi-outlet distribution boxes into only one of the outlets. This unreliable effluent loading is the most common cause of malfunction, especially in the most common slow-flow absorption systems. Thus, the historic failure of our distribution devices cries out for improvement. All wastewater professionals have faced this necessity. That is why so many possibilities have been tried for so long. This unique invention proposes a simple, low cost solution.

Dosing the effluent is well known to produce a more efficient method of distribution. The dose is more even and flows throughout the absorption area. Most dosing systems use a pump or siphon; both U.S. Pat Nos. 4,625,752 and 5,343,888 use this common technology to dose into a separate distribution unit. U.S. Pat. No. 4,838,731 describes a dipper distribution box that collects and doses the effluent when applied to a “trickle” flow leaching system. The means for dosing is a dipper trough that dumps directly into the large diameter outlets. There is no intention or potential to pressurize the discharge for a more efficient distribution as is the intended design of this patent application.

It is also well known that a pressure manifold device will equalize flow extremely accurately if kept under adequate liquid pressure throughout the dose period. U.S. Pat. No. 5,988,943 describes a manifold device intended to be used in a pressure or gravity system. Its design incorporates a fitting for each use. The pressure mode requires connection to a separate “pressure operated distribution box”; this implies either a siphon or pump operated device. Pressure manifolds have been used for many years; and when designed by engineers, they are very effective. The gravity mode requires the installed device to be leveled by carpenter's level or transit to accomplish equal distribution. In the field, the device is dependent on precise leveling and a system flow rate greater than the most common trickle flow for any hydraulic gradient to produce adequate pressure distribution. In practice, this device operates like most other D-boxes that are dependant on field leveling for flow control.

The combination of these two well-known principles (dosing and pressure manifold) for equal liquid distribution does produce a more efficient technology for septic waste distribution. With the addition of a uniquely designed automatic collection/dosing mechanism, this invention proposes a very practical approach to significantly improve wastewater treatment in our most commonly used gravity-flow soil absorption systems.

### SUMMARY OF THE INVENTION

This distribution device is comprised of a collection chamber constructed with an inlet orifice from the septic tank and a dosing outlet in the bottom; attached directly below is a smaller pressure chamber with a number of small diameter outlet pipes of equal inner diameter and length. The larger upper chamber collects the effluent dose volume until a unique double float mechanism automatically opens a discharge valve dosing the collected volume into the lower chamber immediately filling the entire capacity of this smaller chamber. The automatic dosing device is activated when the water level within the collection chamber rises to a certain level tripping the flapper-dosing valve. A siphon can also be used to collect and discharge the effluent.

The dose volume continues to flow from the larger collection chamber to the smaller pressure chamber until the entire collected volume exits the upper chamber. Since the lower pressure chamber's small diameter outlet pipes' discharging capacity is less than the inflow capacity, a hydraulic head pressure is established within the smaller lower chamber, forcing the effluent through the outlet pipes in equal volumes since each pipe is of equal length and diameter. The outlet pipes are connected to the distribution lines of the absorption system. Thus, equal effluent distribution to each absorption line within a slow-flow, gravity system is accomplished by automatically collecting, dosing and pressurizing the effluent discharge in a continuous repetitive cycle.

### DRAWINGS—FIGURES

FIG. 1a is a sectional illustration of the collection/dosing chamber containing the dosing mechanism and the pressure distribution chamber. This drawing shows the flange cocked and set on the knob-catch due to the initial buoyancy of the bottom float as the collection chamber fills with liquid influent.

FIG. 1b is a side sectional illustration of the same stage of liquid influent level as FIG. 1a.

FIG. 2a is a sectional illustration similar to FIG. 1a with the liquid influent rising to the level allowing the top float to become buoyant changing the flange to a vertical position and releasing the flange from the knob-catch.

FIG. 2b is a side sectional illustration of the same stage of liquid influent level as FIG. 2a.

FIG. 3a is a sectional illustration similar to FIG. 2a as the buoyancy pressure of both floats lifts the flange and opens the flapper valve allowing the entire collected liquid to flow into the pressure chamber and distributed through each outlet.

FIG. 3b is a side sectional illustration of the same stage of liquid influent level as FIG. 3a.

FIG. 4a is a sectional illustration similar to FIG. 1a as the liquid has drained from the collection chamber and the floats have receded allowing the flapper valve to close and seal.

FIG. 4b is a side sectional illustration of the same stage of liquid influent level as FIG. 4a.

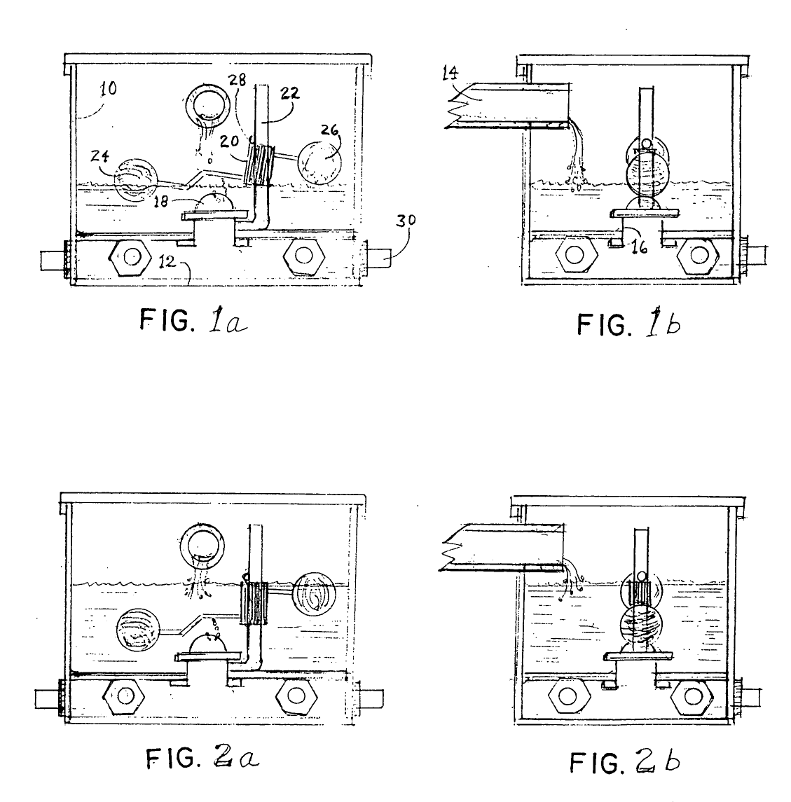

### DRAWINGS

### Reference Numerals

10 collection chamber
12 pressure chamber
14 influent pipe from septic tank
16 drain orifice
18 flapper valve
20 flange
22 standpipe
24 bottom float
26 top float
28 knob-catch
30 outlet pipes

### DETAILED DESCRIPTION OF THE PREFERRED EMBODIMENT

The construction of the chambers of this distribution device can be made of any ridged material of a waterproof nature. The collection chamber (10) is a receptacle for the septic tank effluent entering through the rear sidewall in plastic pipe (14). The pressure chamber (12) is attached directly below the collection chamber (10) and connected through a drain orifice (16), sealed by a flapper valve (18).

The automatic dosing mechanism is comprised of a flange (20), which slides freely around a standpipe (22) that is rigidly connected to the flapper valve (18) assembly. Two floats are connected to the flange (20). The bottom float (24) is connected to the lower end of the flange (20) and the top float (26) is connected to the upper end. A knob-catch (28) protrudes slightly from the side surface of the standpipe (22). The flapper valve (18) is tethered to the flange (20) assembly.

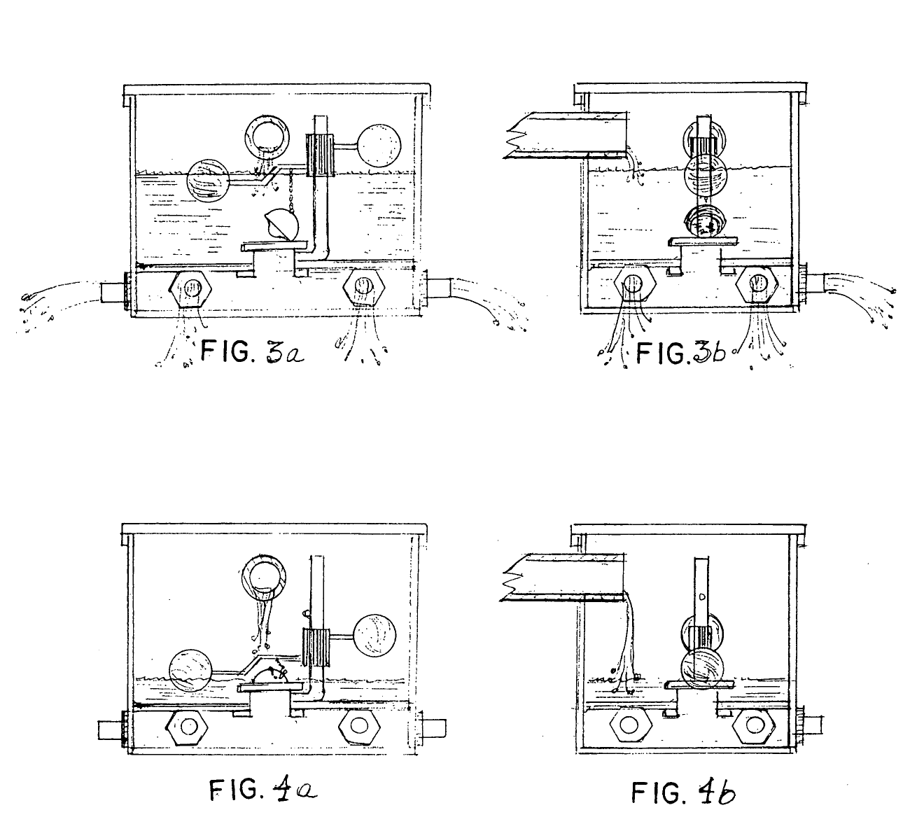

The pressure chamber's outlet pipes (30) are short lengths of small diameter pipe fastened through the rigid sidewalls of the pressure chamber (12). All the outlet pipes (30) are of equal length and inner diameter. Each outlet pipe connects to one of the absorption system's drain field lines. FIGS. 3a & 3b illustrates the equal pressure flow through all of the outlet pipes. Actual installation of this device will connect each outlet into the end cap of a separate drain field line.

A guide to keep the flange in alignment with the knob-catch may be adapted in order to assist precise operation of the automatic dosing assembly. This, and a variety of other modifications to the features described here as the preferred embodiment, may become apparent as adaptations of this invention. All variations that fall within the spirit of the invention are intended to be included within the scope of the claims presented here.

### OPERATION OF INVENTION

This invention is designed to significantly improve the critical distribution of wastewater into soil absorption, slow-flow gravity drain fields. The liquid distribution device is comprised of a collection chamber for storing effluent flowing from a septic tank in a trickle-flow system, a trip dosing mechanism for gravity dosing the volume, and a pressure chamber that evenly distributes the effluent into drain lines.

The liquid collection chamber has a side influent orifice to receive the septic tank effluent and a bottom orifice to discharge into a lower chamber used as a pressure distribution chamber, which can be described as a “false bottom” of the upper collection chamber. This lower, smaller chamber receives the dosed volume from the same discharge orifice of the upper collection chamber. The outlets from the pressure chamber are comprised of a plurality of small equal diameter pipes of equal length connected to the sidewalls of the pressure chamber. Each outlet pipe connects to one of the absorption system's drain lines by insertion into the end cap.

The trip dosing mechanism is comprised of a double float device, as shown in FIG. 1a, the preferred embodiment; a siphon can also be used as a dosing mechanism. The double float dosing mechanism described here consists of a flapper flush valve with an overflow standpipe and a short flange, which slides freely around the standpipe. A bottom float is connected to the lower end of the flange and another top float is connected to the upper end of the flange. A “knob-catch” protrudes slightly from one surface of the standpipe. A flapper flush valve is tethered to the lower float and flange. This trip dosing mechanism controls the collection and dosing of the liquid volume in a completely automatic and continuous cycle of storage and discharge.

Since the automatic dosing mechanism is a significantly novel innovation, which makes this device so unique in its function, a clear explanation of the operation is offered. The specifications describe the construction of the double float device with the flapper valve, standpipe, and plastic flange (used as a collar around the standpipe) with a bottom and top float attached. With the flapper valve closed, the influent liquid collects in the large upper chamber. As the liquid rises within this collection chamber, the bottom float attached to the plastic flange becomes buoyant and cocks the flange against the “knob catch” on the standpipe. This catch holds the bottom float and flange from rising as the liquid collects in the chamber. The liquid level will continue to rise in the collection chamber until the liquid rises to a height, which will make the top float become buoyant. At this point, the flange will automatically revert to a vertical position around the standpipe and release the flange from the “knob-catch”. The buoyancy pressure from both floats is sufficient to lift the flapper valve attached by tether to the bottom float. The flapper valve will remain open until the floats recede with the drained liquid volume. When the collection chamber is emptied the flapper valve reseals over the discharge orifice and collection of the liquid volume begins again for the next dose.

1. A liquid distribution devise, comprising:
1. a collection chamber for collecting a liquid volume flowing by gravity from a septic tank or other vessels,
2. a pressure chamber connected to said collection chamber for distributing the collected liquid volume in equal amounts through a plurality of outlets,
3. means for automatically collecting the liquid volume in said collection chamber and for automatically dosing the liquid volume into the said pressure chamber,
whereby the mechanism for automatically collecting and dosing the liquid volume establishes continuous cyclic stages of storage and distribution.
